(19) United States
(12) Patent Application Publication
(10) Pub. No.: US 2002/0077166 A1
(43) Pub. Date: Jun. 20, 2002

(54) Word linking game apparatus and method for playing same

(76) Inventor: Ronald R. Ferguson, Sunrise, FL (US)

Correspondence Address: David P. Lhota, Stearns Weaver Miller, Suite 1900, 200 East Broward Boulevard, Fort Lauderdale, FL, 33301, US

(21) Appl. No.: 09/971,104

(22) Filed: Oct. 4, 2001

Related U.S. Application Data
(60) Provisional application No. 60/237,969, filed on Oct. 4, 2000.

(51) Int. Cl. A63F 13/00

(52) U.S. Cl. 463/9

(57) ABSTRACT

A word association and linking game apparatus and method for playing the game including a plurality of word fields having predetermined words therein, a plurality of empty fields corresponding to the word fields at a ratio of at least two word fields per empty field, at least one clue and a result arranged in a tournament like manner. At least two word fields link to a common empty field and the player must enter a word that is common to both as either a compound word or a well recognized phrase. Clues may be provided, such as in the form of a sentence, wherein the answer would also complete the sentence. The game includes a timing requirement where players would have limited time for filling in the empty fields. Electronic or computer versions utilizing software may also be provided.

### CROSS REFERENCE TO RELATED APPLICATIONS

This application claims the benefit of provisional application Serial No. 60/237,969 filed Oct. 4, 2000.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates generally to games, and more particularly, to a word game having a plurality of fields for receiving words that link with clue words.

2. Description of the Background Art

Word games are well known in the art. Some examples of word games include Scrabble, Jumble and crossword. Scrabble involves the building of words with letter blocks. Jumble is a game where words are derived from a series of letters and the final puzzle answer is derived from select letters in the derived words. Crossword comprises a numbered grid and a series of clues for finding the words that fit in designated segments of the grid. Games such as these build on important skills associated with vocabulary and spelling. Another important language skill is the ability to create or recognize an association between words. There is no game known, however, that teaches or enhances word association skills by linking known words with a common word, as contemplated by the instant invention.

Several other conventional games are known in the background art. However, none of these addresses or resolves the foregoing shortcomings in the prior art. For instance, U.S. Pat. No. 4,215,864, issued to Nichols, discloses a word puzzle game similar to crossword and comprising a substrate which carries a letter field of spaces, a set of word clues and a puzzle statement whose solution is dependent upon the proper solution of the word clues. U.S. Pat. No. 4,940,239, issued to Tuttle, discloses a board game apparatus including a plurality of player position marking pieces and a game board having a playing area with an endless path arranged to divide symmetrically the playing area into smaller areas for receiving individual decks of question and answer playing cards. The game employs cards each containing a quotation or definition with one missing word on one side and missing word answer on the other side and requires the players to determine that word. U.S. Pat. No. 5,213,33 issued to Petrovich, et al discloses a word association game wherein the players derive different but commonly known word sets from elements of a previous commonly known set including a die, a board a plurality of preprinted cards, a “minute glass” timer, a plurality of pads, writing instruments and game tokens for movement on the board. Players have a predetermined amount of time to enter successive word sets on a scorecard based on the provided word sets. U.S. Pat. No. 4,907,807 discloses a board game for playing crossword puzzles. While the foregoing prior art discloses various word games, the prior art fails to disclose a word association linking game in accordance with the instant invention.

As the above noted art fails to provide a word association game that requires a player to find a common word that links with at least two known words. A new game that facilitates these skills would be welcomed. The instant invention provides such a game.

### SUMMARY OF THE INVENTION

Based on the foregoing, it is a primary object of the instant invention to provide a new, useful and non-obvious game that teaches and enhances word association skills.

It is also an object of the instant invention to provide a word association game that requires players to find the linking word that associates with at least two provided words.

It is an additional object of the instant invention to provide a word association game that can be adapted for play in newspapers, on a computer-based unit, as a board game or on a hand-held unit.

In light of these and other objects, the instant invention comprises a word association and linking game apparatus and method for playing the game. The instant invention is preferably adapted for written publications, such as newspapers and books, but may also be adapted for a television show, on-line computer game for play through a global accessible network such as the Internet, hand-held computer game or board game. The instant invention comprises a plurality of word fields having predetermined words therein, a plurality of empty fields corresponding to the word fields at a ratio of at least two word fields per empty field, at least one clue and a result. In its most basic configuration, the instant invention provides at least two word fields each having at least one word provided therein. At least two word fields link to a common empty field and the player must enter a word that is common to both as either a compound word or a well recognized phrase. A clue may be provided, such as in the form of a sentence, wherein the answer would also complete the sentence. The word fields and empty fields may be arranged in a tapered, tournament-like format, in the form of a sentence having an empty field and corresponding word fields or in a table format wherein a plurality of word fields would all have one common empty field. The game of the invention may also include a timing requirement where players would have limited time for filling in the empty fields. In the electronic or computer versions, the invention includes a software program of processor readable code for operating the game and accessing word and answer data in a database, a database for storing and organizing word and word related data, a user interface and a display.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is an illustrative view of a first puzzle in accordance with the preferred embodiment of the instant invention illustrating the initial set up of a game.

FIG. 2 is an illustrative view of a second puzzle in accordance with the preferred embodiment of the instant invention illustrating the initial set up of a game.

FIG. 3 is an illustrative view of a third puzzle in accordance with the preferred embodiment of the instant invention illustrating the initial set up of a game.

FIG. 4 is an illustrative view of the first puzzle in accordance with the preferred embodiment of the instant invention illustrating a completed set of linking words.

FIG. 5 is an illustrative view of the second puzzle in accordance with the preferred embodiment of the instant invention illustrating a completed set of linking words.

FIG. 6 is an illustrative view of the third puzzle in accordance with the preferred embodiment of the instant invention illustrating a completed set of linking words.

FIG. 7 is an illustrative view of a fourth puzzle in accordance with the preferred embodiment of the instant invention illustrating the initial set up of a game.

FIG. 8 is an illustrative view of a fourth puzzle in accordance with the preferred embodiment of the instant invention illustrating the initial set up of a game with a first clue in the form of a sentence.

FIG. 9 is an illustrative view of a fourth puzzle in accordance with the preferred embodiment of the instant invention illustrating the initial set up of a game with a second clue that provides the first letter of each missing link.

FIG. 10 is an illustrative view of the fourth puzzle in accordance with the preferred embodiment of the instant invention illustrating a first partial set of linking words with a third clue that provides the first two letters of each missing link.

FIG. 11 is an illustrative view of the fourth puzzle in accordance with the preferred embodiment of the instant invention illustrating a second partial set of linking words with a fourth clue that provides the first three letters of each missing link.

FIG. 12 is an illustrative view of the fourth puzzle in accordance with the preferred embodiment of the instant invention illustrating a completed set of linking words and the final solution.

FIG. 13 is an illustrative view of another embodiment of the instant invention illustrating a word substitute and sentence completion version of the game.

FIG. 14 is an illustrative view of another embodiment of the instant invention illustrating another version of the game.

FIG. 15 is an illustrative view of another embodiment of the instant invention illustrating another version of the game shown in FIG. 14.

### DETAILED DESCRIPTION OF THE INVENTION

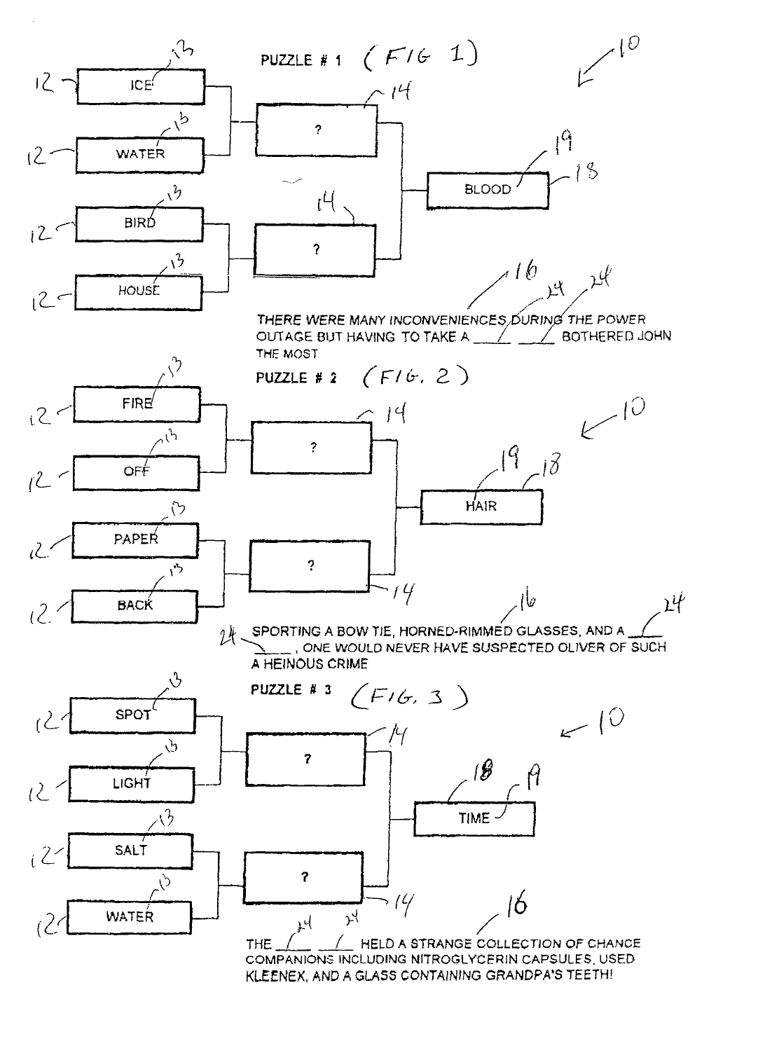

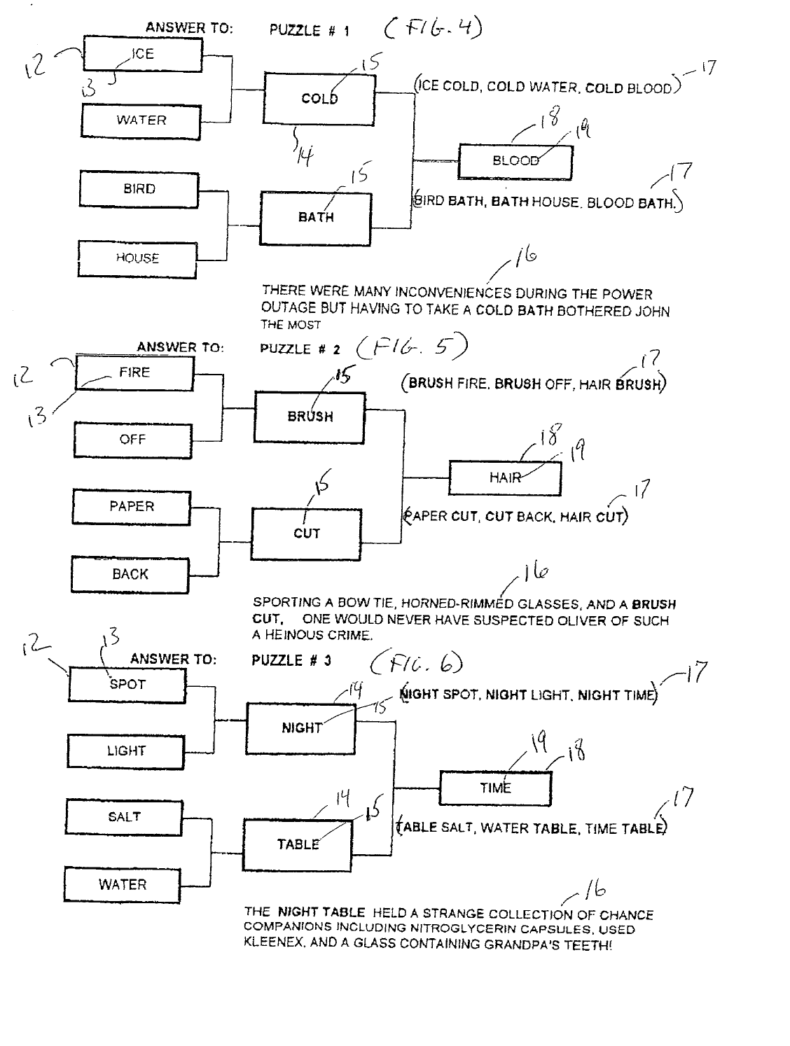

With reference to the drawings, FIGS. 1-15 depict the preferred and alternative embodiments of the instant invention which is generally characterized as a word linking game and by reference numeral 10. The instant invention 10 comprises a word association and linking game apparatus and method for playing the game (“word linking game”). Referring to FIGS. 1-12, the word linking game 10 comprises at least one set of a plurality of word fields 12 having predetermined words 13 therein, at least one empty field 14 corresponding to the word fields 12 at a ratio of at least two word fields 12 per empty field 14, at least one word clue 13 in each word field 12 and at least one predetermined result 15, such as those shown in FIGS. 4-6 and 12, corresponding to the word clues 13 and insertable in and viewable from the empty field 14. The preferred embodiment of the word linking game 10 may also include a final result field 18 and final word clue 19 therein. The final word clue 19 may be omitted in an alternative embodiment to increase the challenge of the word linking game 10.

In its most basic configuration, the instant invention provides one known word set having two word fields 12 each having one known word 13 provided therein and a corresponding result set having one empty field 14 for inserting the result 15. The word linking game 10 may comprise more than two known word sets having any predetermined number of word fields 12 for each empty field 14 and result 15 to be entered therein by the player. For instance, there may be three word fields 12 per empty field 14 or per a pair of empty fields 14. The level of difficulty may be adjusted by changing the number of sets of word fields 12 and empty fields 14 and, or the ratio of word fields 12 to empty fields 14. The empty fields 14 are linked in a second level/degree to the final result field and word clue 18, 19. Alternatively, the tournament-like chain and method of grouping may be expanded and carried out for higher degrees of word fields 12, empty fields 14 and results 15, e.g. third, fourth and higher degrees, to increase the challenge and difficulty of the game. For instance, a fourth degree challenge may start with sixteen (16) word fields 12 with clues 13 and taper down to eight (8) empty fields, four empty fields 14 or word fields 12, two (2) empty fields 14 or word fields 12 and final result field and clue 18, 19, so long as a plurality of word clues 13 are being used to derive the results for the empty fields 14. Regardless of the size of the puzzle, a final result 15 is obtained to solve a main puzzle, question and/or search for a word. The word linking game 10 may also include confirmation templates 17 which confirm the final results 15. The word linking game 10 may be adapted for written publications, game shows for television or other media, on-line computer games played through a global accessible network such as the Internet, hand-held computer games or board games. Accordingly, the word fields and empty fields 12, 14, 18 may comprise a printed space/line/block, computer structure, database field and the like.

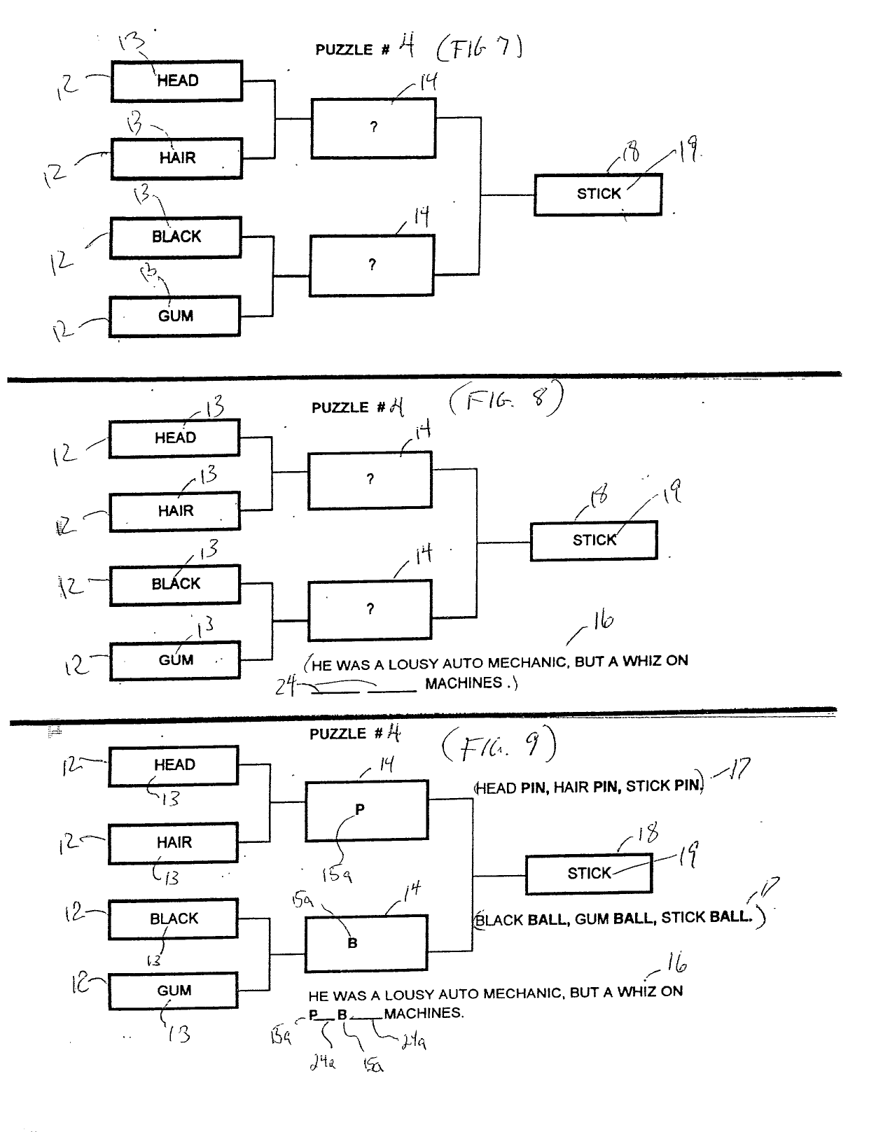

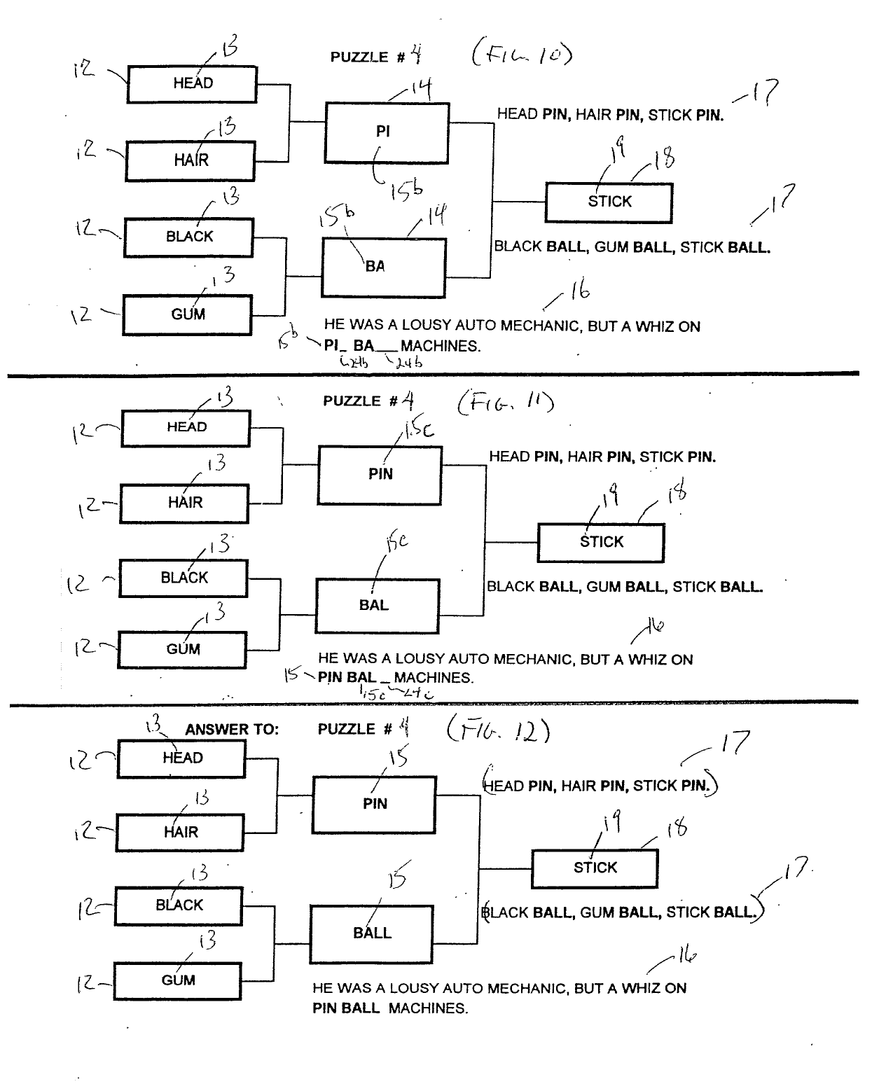

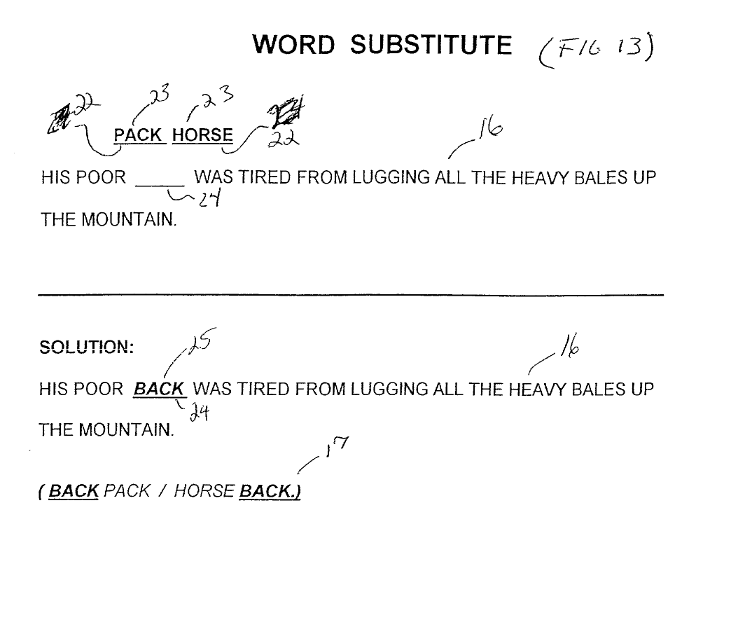

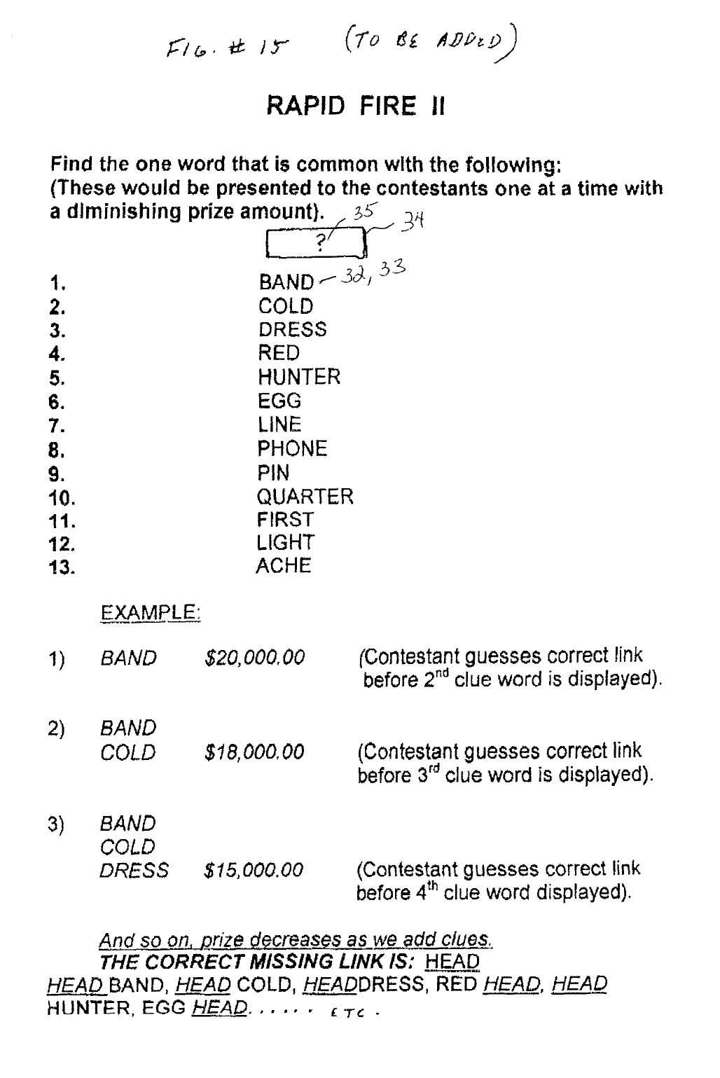

With reference to FIGS. 1-3 and 7-8, two sets of word fields 12 and corresponding empty fields 14 are shown. Referring to FIGS. 7-12, the progression of the game and provision of clues are shown. At least two word fields 12 link to a common empty field 14 and the player must enter a word 15 that is common to the corresponding word clues 13 and the final word clue 19 as either a compound word or a well recognized phrase. Clues may be provided, such as in the form of a sentence 16, wherein the result 15 would also complete the sentence 16, or by providing at least one or more letters 15a-c that are present in the result 15, as shown in FIGS. 9-11. The word fields 12 and empty fields 14 may be arranged in a tapered, tournament-like format as shown in FIGS. 1-12, in the form of a sentence 16 having an empty field 24 and corresponding word fields 22, 23, as shown in FIG. 13, or in a table format, as shown in FIG. 14, wherein a plurality of word fields 32 and corresponding words 33 would all have one common empty field 34 and result 35.

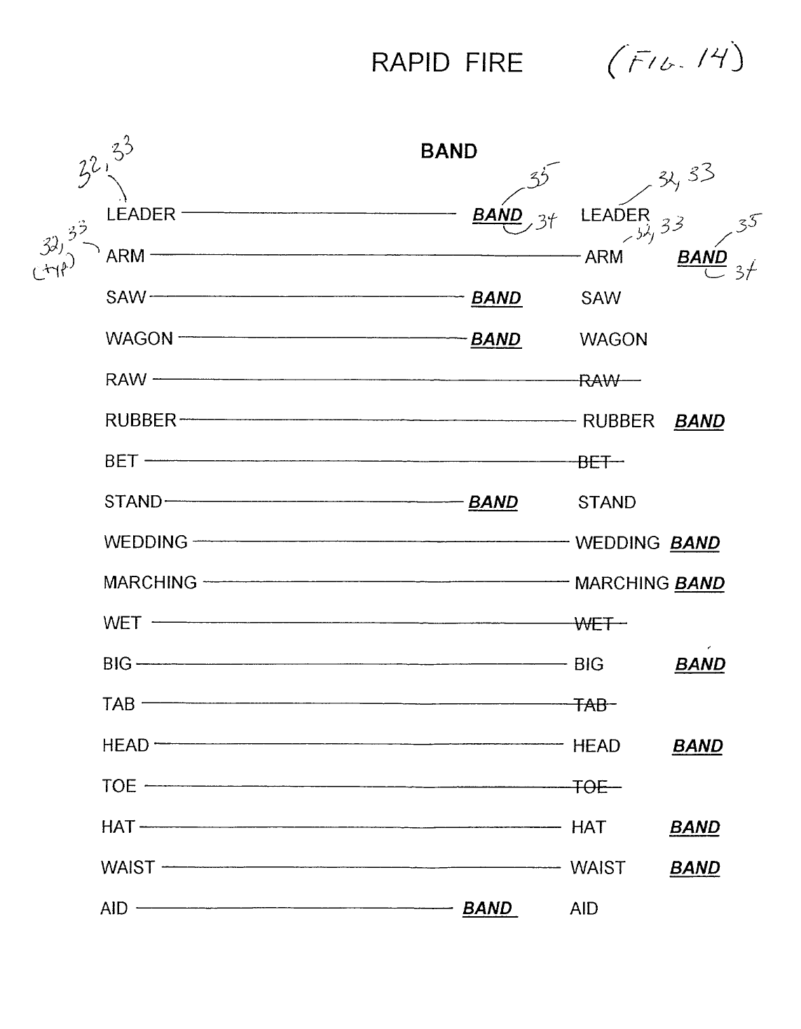

Examples of the word linking game 10 are shown in FIGS. 1-12. Referring to FIG. 1, a first set of word fields 12, 13 comprises “ice” and “water,” a second set of word fields 12, 13 comprises “bird” and “house” and a final word clue 19 comprise “blood.” The player must find the word results 15 that are common to “ice” and “water” and “bird” and “house,” respectively, and which link to the final word result “blood” 19 in field 18. A result 15 for each set in this example completes a two-word phrase. Referring to FIG. 4, the results 15 corresponding to FIG. 1 comprise “cold” for the first set and “bath” for the second set. Referring to FIGS. 1 and 4, the final word clue 19 is “blood” and confirms the results 15 “cold” and “bath”, as supported by confirmation template 17. In an alternative example, field 18 could be empty so as to be filled with a final result by the player. Confirmation templates 17 may be provided for each puzzle. Similar examples to those shown in FIGS. 1 and 4 are shown in FIGS. 2-3 and 5-12. With reference to FIGS. 1-12 and 13, a sentence clue 16 may be provided with an empty field 24 for receiving a result 15 that corresponds to both the puzzle and sentence 16. In other embodiments, pre-selected letters 15a-c may be provided in the sentence clue 16, empty word field 14 and/or other aspects of the game to assist the player in solving the puzzle. The instant invention can be set up to provide prizes or monetary awards for winners based on the speed in which the results 15 are found or the number of clues required before the correct results are found. For instance, referring to FIGS. 7-12, a player would win the most money in FIG. 7, less money in FIGS. 8-10, the least money in FIG. 11 and no money in FIG. 12.

Additional embodiments of the instant invention are shown in FIGS. 13-15. With reference to FIG. 13, another embodiment of the invention may comprise a sentence 16 having at least one empty field 24 therein and word field clues 22, 23 and a corresponding solution 25. This version of the word linking game is referenced as a “word substitute” game (trademark of Applicant). With reference to FIGS. 14 and 15, the instant invention may comprise a speed game (under Applicant's trademarks “Rapid Fire”) wherein a group of word fields 32, each having a known word clue 33 therein, all have the same corresponding result 35. The results 35 are stored and displayed in result field 34. In this embodiment, the player must find the result 35 in a predetermined period of time. A player is given one clue 33 at a time. The best awards, such as the largest dollar figure, are preferably won by finding the result 35 with only one clue 33. The amount of money or value of the prize decreases with each additional clue 33, as shown in FIG. 15. With reference to FIG. 15, a second embodiment of the speed game (under Applicant's trademark “Rapid Fire II”) is shown. A timing requirement may be incorporated into any embodiment of the game wherein players would have limited time for filling in the empty fields. In the electronic or computer versions, a software program of processor readable code provides operational instructions based on predetermined conditions satisfying the rules of the game embodied by the instant invention. A processor capable of reading and processing the software may be included in a hand-held electronic version of the game. The game 10 of the invention may further include software that is stored, read and processed on a compact disc adaptable for use in any conventional computer. The software and game 10 may also be made available on a globally accessible network, such as the Internet.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A word association game, said game comprising:
at least one set of fields, said fields including at least two word fields and at least one empty field corresponding to said word fields;
each of said word fields including at least one word clue therein; and
said empty field having means for receiving at least one word result input corresponding to said word clues to derive a final result.

2. A game as recited in claim 1, wherein said game further comprises:
at least two sets of fields.

3. A game as recited in claim 2, wherein said final result comprises:
a predetermined pattern of words.

4. A game as recited in claim 1, wherein said means for receiving comprises:
a box-like space adapted for receiving said word result input by a writing instrument.

5. A game as recited in claim 1, wherein said means for receiving comprises:
an electronic field adapted for electronically receiving said word result input when prompted by user inputs.

6. A game as recited in claim 5, wherein said game further comprises:
a hand held unit having a processor and a set of processor readable code, said processor readable code controlling the processing of said word fields, empty fields, word result inputs and final result.

7. A game as recited in claim 7, wherein said game further comprises:
a set of processor readable code, said processor readable code controlling the processing of said word fields, empty fields, word result inputs and final result.

8. A game as recited in claim 1, further comprising:
a final word clue that corresponds to said word result inputs to provide information useable in deriving said final result.

9. A game as recited in claim 1, further comprising:
additional clue means for providing information corresponding to said word result inputs.

10. A game as recited in claim 9, wherein said additional clue means comprises:
at least a portion of a sentence having empty sentence fields corresponding to said empty fields and said word clues.

11. A method for playing a word association game, said method comprising the steps of:
providing a plurality of word fields having predetermined words therein and a plurality of empty fields corresponding to said word fields wherein there are at least two word fields per empty field;
reading said plurality of word fields;
identifying word results that correspond to said words in said word fields for each empty field;
entering each of said word results in said empty fields that correspond to said word results; and
determining whether said word results are a final correct result.
